(19) United States
(12) Patent Application Publication
(10) Pub. No.: US 2025/0372298 A1
(43) Pub. Date: Dec. 4, 2025

(54) PREPARATION METHOD OF SAMARIUM-COBALT PERMANENT MAGNET WITH HIGH MECHANICAL PROPERTIES

(71) Applicant: NINGBO INSTITUTE OF MATERIALS TECHNOLOGY AND ENGINEERING, CHINESE ACADEMY OF SCIENCES, Ningbo (CN)

(72) Inventors: Fangqin HU, Ningbo (CN); Yingli SUN, Ningbo (CN); Yong DING, Ningbo (CN); Aru YAN, Ningbo (CN)

(21) Appl. No.: 18/902,193

(22) Filed: Sep. 30, 2024

(30) Foreign Application Priority Data
May 28, 2024 (CN) 2024106757521

(51) Int. Cl. H01F 41/02; B22F 3/24; H01F 1/055

(52) U.S. Cl. CPC H01F 41/0266; B22F 3/24; H01F 1/0557; B22F 2003/248; B22F 2202/05; B22F 2301/45

(57) ABSTRACT

The invention belongs to the technical field of permanent magnet materials, and relates to a preparation method of a samarium-cobalt permanent magnet with high mechanical properties, comprising the following steps: performing melting, pulverizing, orientation shaping, cold isostatic pressing, sintering, solution, aging and heat treatment sequentially on raw materials to obtain the samarium-cobalt permanent magnet. The number of heat treatment cycles ranges from 1 to 10, and an external magnetic field and an external stress are applied during one or multiple heat treatment cycles. The magnetic field intensity of the external magnetic field is 1-50 kOe, and the magnitude of the external 10 stress is 5-500 MPa. Compared to the traditional process, this method not only improves the magnetic properties, but also greatly enhances the mechanical properties of the samarium-cobalt magnet, achieving a synergistic improvement in the magnetic and mechanical properties.

### BACKGROUND OF THE INVENTION

### 1. Technical Field

The invention belongs to the technical field of permanent magnet materials, and relates to a preparation method of a samarium-cobalt permanent magnet with high mechanical properties.

### 2. Description of Related Art

Samarium-cobalt permanent magnet materials, with their unique high-temperature stability and excellent corrosion resistance, as well as their relatively low temperature coefficients of remanence, are indispensable key materials for the development of high-tech, national defense equipment, modern communication, transportation, and intelligent manufacturing. However, due to their inherent characteristics such as few slip systems and anisotropy, samarium-cobalt materials lack ductility and are difficult to process into complex shapes. During product processing or workflow circulation, inspection, and magnetization, they are very likely to cause corner defects. When subjected to impact vibrations and centrifugal forces during use, they are even more prone to failure. Currently, the bending strength of samarium-cobalt magnets is only 80-140 MPa, and the fracture toughness is only 1.5-2.5 MPa.m^{1/2}. Due to brittleness, production losses can reach 20-30%, significantly increasing processing costs and severely restricting their application range and further processing.

To improve the mechanical properties of samarium-cobalt permanent magnet materials, researchers have conducted extensive research. A heterogeneous powder mixture is formed By adding high-melting-point oxides during the powder preparation stage, the mechanical properties of the magnets are effectively improved, but the magnetic properties deteriorate significantly. A protective coating on the surface can improve the mechanical properties and consistency, but the improvement is limited, and the magnetic properties are reduced.

Therefore, how to achieve improved mechanical properties of the magnets while maintaining or even enhancing their magnetic properties is the current research focus for samarium-cobalt permanent magnet materials.

### BRIEF SUMMARY OF THE INVENTION

In order to solve the above problems in the prior art, the purpose of the invention is to provide a preparation method of a samarium-cobalt permanent magnet with high mechanical properties, and the prepared samarium-cobalt permanent magnet has excellent mechanical properties, so as to overcome the shortcomings of the prior art.

An object of the invention is achieved by the following technical scheme.

A preparation method of a samarium-cobalt permanent magnet with high mechanical properties comprises the following steps:

performing melting, pulverizing, orientation shaping, cold isostatic pressing, sintering, solution, aging and heat treatment successively on raw materials to obtain the samarium-cobalt permanent magnet.

The heat treatment is conducted in an inert atmosphere. The number of heat treatment cycles ranges from 1 to 10, and an external magnetic field and an external stress are applied during one or multiple heat treatment cycles. Here, “multiple” refers to a number less than or equal to the total number of heat treatment cycles. For example, if the number of heat treatment cycles is 3, the “multiple” here would be 2 or 3.

The number of heat treatment cycles ranges from 1 to 10, and when the number of heat treatment cycles is more than or equal to 2, the temperature is cooled down to 10-50° C. during each heat treatment cycle, and then heated up again for the next heat treatment cycle. The heating rate is preferably 0.8-1.2° C./min. The holding temperature and holding time for each heat treatment cycle may be the same or different.

Preferably, the holding temperature for each heat treatment cycle is 350° C.≤T<Curie temperature, more preferably 400° C.≤T≤850° C.

Preferably, the holding time for each heat treatment cycle is 3-90 min, more preferably 5-60 min.

Preferably, each heat treatment cycle consists of one or two stages, and the external magnetic field and the external stress are applied during one of the stages or both stages.

When the heat treatment cycle consists of one stage, the holding temperature for the one-stage heat treatment is 350° C.≤T<Curie temperature, more preferably 400° C.≤T<850° C.; and the holding time for the one-stage heat treatment is 3-90 min, more preferably 5-60 min.

When the heat treatment cycle consists of two stages, the holding temperature for the first-stage heat treatment is 350° C.≤T<Curie temperature (more preferably 400° C.≤T≤850° C.), and the holding time is 3-90 min (more preferably 5-60 min); and the holding temperature for the second-stage heat treatment is 350° C.≤T<Curie temperature (more preferably 400° C.≤T≤850° C.), and the holding time is 3-90 min (more preferably 5-60 min).

More preferably, when the heat treatment cycle consists of two stages, the holding temperature for the first-stage heat treatment is 700-850° C., and the holding time is 3-90 min (more preferably 5-60 min); and the holding temperature for the second-stage heat treatment is 350-600° C., and the holding time is 3-90 min (more preferably 5-60 min).

Each heat treatment cycle comprises a heating step, a holding step and a cooling step. Preferably, the external magnetic field and the external stress are applied to any one step or any two steps or throughout the entire heat treatment cycle.

Preferably, a magnetic field intensity of the external magnetic field is 1-50 kOe, more preferably 3-20 kOe, and still more preferably 5-10 kOe.

Preferably, the external magnetic field is located at both sides of a sample, and the sample is placed at a center of the magnetic field.

Preferably, the external magnetic field is applied in one of the following directions: horizontal, vertical, or at any angle.

Preferably, a direction of the external magnetic field is parallel to an easy magnetization axis of a sample.

Preferably, the magnitude of the external stress is 5-500 MPa, more preferably 30-300 MPa, and still more preferably 50-200 Mpa.

The stress is directly applied to the magnet by using a fixture, a press or other mechanical equipment, and a medium for the external stress is a magnetically permeable material or a non-magnetically permeable material, preferably a non-magnetically permeable material.

Preferably, a direction of the external stress is parallel to the direction of the external magnetic field.

Preferably, the inert atmosphere is nitrogen and/or argon. The purity of nitrogen and/or argon is ≥99.99%.

Another object of the invention is achieved by the following technical scheme.

A samarium-cobalt permanent magnet with high mechanical properties is prepared by the above preparation method.

Preferably, a maximum bending strength of the samarium-cobalt permanent magnet is >150 MPa. More preferably, the maximum bending strength is ≥220 MPa. Still more preferably, the maximum bending strength is 290-400 MPa.

Compared with the prior art, the invention has the following beneficial effects.

According to the invention, heat treatment with the application of an external magnetic field and an external stress is performed after the aging process is completed. Compared to the traditional process, this method not only improves the magnetic properties, but also greatly enhances the mechanical properties of the samarium-cobalt magnet, achieving a synergistic improvement in the magnetic and mechanical properties.

According to the invention, multiple heat treatment cycles with the application of an external magnetic field and an external stress are performed after the aging process is completed. Compared to a single heat treatment cycle, this approach results in a significant improvement in both the coercivity and mechanical properties.

The improved bending strength of the samarium-cobalt magnet allows for further processing into complex shapes, reducing processing losses and lowering manufacturing costs, thereby significantly expanding the application range.

### BRIEF DESCRIPTION OF THE SEVERAL VIEWS OF THE DRAWINGS

FIG. 1 is a process diagram of sintering, solution treatment, aging and heat treatment of a samarium-cobalt permanent magnet;

FIG. 2 is a graph showing the magnetic properties of a samarium-cobalt magnet according to Embodiment 7 of the invention;

FIG. 3 is a graph showing the magnetic properties of a samarium-cobalt magnet according to Comparative example 1 of the invention;

FIG. 4 is a bending stress-strain diagram of a samarium-cobalt magnet according to Embodiment 7 of the invention; and

FIG. 5 is a bending stress-strain diagram of a samarium-cobalt magnet according to Comparative example 1 of the invention.

### DETAILED DESCRIPTION OF THE INVENTION

Hereinafter, the specific implementation modes involving melting, pulverizing, orientation shaping, cold isostatic pressing, sintering, solution treatment, aging and heat treatment in a preparation method of a samarium-cobalt permanent magnet with high mechanical properties will be described in detail. However, these implementation modes are merely examples, and the disclosure of the invention is not limited to these.

There are two types of samarium-cobalt permanent magnets, samarium-cobalt 1:5 and samarium-cobalt 2:17, and this should not be used to limit the protection scope of the invention.

Melting: Weigh and mix raw materials according to the molecular formula of the samarium-cobalt permanent magnet, with an additional compensation amount for samarium during the mixing process; place the raw materials in a vacuum melting furnace, evacuate the furnace to a vacuum degree of less than 1×10⁻¹ Pa, and then fill with an inert gas; heat to 1400-1500° C. for melting, hold for 1-30 min, and then pour a high-temperature alloy solution into a water-cooled copper mold to form an alloy ingot. The above melting steps are only exemplary and cannot be used to limit the protection scope of the invention.

Pulverizing: Coarsely crush the alloy ingot obtained in the melting process to below 300 μm, and perform jet milling on the coarse magnetic powder obtained after coarse crushing to generate magnetic powder with a particle size of 1-6 μm. The above pulverizing steps are only exemplary and cannot be used to limit the scope of protection of the invention.

Orientation shaping and cold isostatic pressing: Place the magnetic powder obtained in the pulverizing process in a magnetic field press with a magnetic field intensity of 0.5-5 T under the protection of an inert atmosphere for orientation shaping, vacuum-package a prepared green compact, and place it in isostatic pressing equipment, where it is compressed at 50-300 MPa for 5-60 s to produce a samarium-cobalt permanent magnet alloy blank. The above orientation shaping and cold isostatic pressing steps are only exemplary and cannot be used to limit the protection scope of the invention.

FIG. 1 is a process diagram of sintering, solution treatment, aging and heat treatment of a samarium-cobalt permanent magnet according to the invention. The specific steps are as follows.

Sintering: Pre-sinter the samarium-cobalt permanent magnet alloy blank obtained by cold isostatic pressing at 1100-1180° C. for 0.5-2 h, and then heat to 1170-1250° C. in an inert atmosphere and sinter for 1-5 h. The above sintering steps are only exemplary and cannot be used to limit the protection scope of the invention.

Solution treatment: The solution treatment temperature is 10-20° C. lower than the sintering temperature, and the solution treatment lasts 2-6 h, followed by cooling to room temperature to obtain a samarium-cobalt permanent magnet solid solution. The above solution treatment steps are only exemplary and cannot be used to limit the protection scope of the invention.

Aging: In an inert atmosphere, heat the samarium-cobalt permanent magnet solid solution to 750° C.≤T<Curie temperature (more preferably 800° C.≤T≤850° C.) for isothermal aging treatment for 10-30 h, then slowly cool to 300-500° C. at 0.3-1.0° C./min, hold for 1-5 h, and finally cool naturally in the furnace to room temperature to obtain a samarium-cobalt sample.

The above aging steps are only exemplary and cannot be used to limit the scope of protection of the invention. The aging process may also include multi-stage aging treatment or repeated aging treatment for samarium-cobalt 1:5-type magnets and samarium-cobalt 2:17-type magnets.

### Heat Treatment

The heat treatment is conducted in an inert atmosphere. The number of heat treatment cycles ranges from 1 to 10, and an external magnetic field and an external stress are applied during one or multiple heat treatment cycles. Here, “multiple” refers to a number less than or equal to the total number of heat treatment cycles. For example, if the number of heat treatment cycles is 3, the “multiple” here would be 2 or 3; and if the number of heat treatment cycles is 10, the “multiple” here may be 2, 3, 4, 5, 6, 7, 8, 9 or 10.

When the number of heat treatment cycles is more than or equal to 2, the temperature is cooled down to 10-50° C. during each heat treatment cycle, and then heated up again for the next heat treatment cycle. The holding temperature and holding time for each heat treatment cycle may be the same or different.

Preferably, the holding temperature for each heat treatment cycle is 350° C.≤T<Curie temperature, more preferably 400° C.≤T<850° C. Preferably, the holding time for each heat treatment cycle is 3-90 min, more preferably 5-60 min.

Preferably, each heat treatment cycle consists of one or two stages, and the external magnetic field and the external stress are applied during one of the stages or both stages. When the heat treatment cycle consists of one stage, the holding temperature for the one-stage heat treatment is 350° C.≤T<Curie temperature, more preferably 400° C.≤T≤850° C.; and the holding time for the one-stage heat treatment is 3-90 min, more preferably 5-60 min. When the heat treatment cycle consists of two stages, the holding temperature for the first-stage heat treatment is 350° C.≤T<Curie temperature (more preferably 400° C.≤T≤850° C.), and the holding time is 3-90 min (more preferably 5-60 min); and the holding temperature for the second-stage heat treatment is 350° C.≤T<Curie temperature (more preferably 400° C.≤T≤850° C.), and the holding time is 3-90 min (more preferably 5-60 min).

More preferably, when the heat treatment cycle consists of two stages, the holding temperature for the first-stage heat treatment is 700-850° C., and the holding time is 3-90 min (more preferably 5-60 min); and the holding temperature for the second-stage heat treatment is 350-600° C., and the holding time is 3-90 min (more preferably 5-60 min).

Each heat treatment cycle comprises a heating step, a holding step and a cooling step. The heating rate is 0.8-1.2° C./min. The cooling can be done either by furnace cooling or at a rate of 1-50° C./min. The heat treatment steps may be identical or they can vary. Preferably, the external magnetic field and the external stress are applied to any one step or any two steps or throughout the entire heat treatment cycle.

Preferably, a magnetic field intensity of the external magnetic field is 1-50 kOe, more preferably 3-20 kOe, and still more preferably 5-10 kOe. Preferably, the magnitude of the external stress is 5-500 MPa, more preferably 30-300 MPa, and still more preferably 50-200 Mpa. Preferably, the inert atmosphere is nitrogen and/or argon. The purity of nitrogen and/or argon is ≥99.99%.

Preferably, the external magnetic field is located at both sides of a sample, and the sample is placed at a center of the magnetic field. Preferably, the external magnetic field is applied in one of the following directions: horizontal, vertical, or at any angle. Preferably, a direction of the external magnetic field is parallel to an easy magnetization axis of a sample.

The stress is directly applied to the magnet by using a fixture, a press or other mechanical equipment, and a medium for the external stress is a magnetically permeable material or a non-magnetically permeable material, preferably a non-magnetically permeable material. Preferably, a direction of the external stress is parallel to the direction of the external magnetic field.

Hereinafter, the technical scheme of the invention will be further described by specific embodiments and attached drawings. It should be understood that the specific embodiments described here are only used to help understand the invention and are not used for specific limitations of the invention. The drawings used herein are only for better explaining the disclosure of the invention, and do not have a limiting effect on the protection scope. Unless otherwise specified, the raw materials used in the embodiments of the invention are all commonly used in this field, and the methods used in the embodiments are all conventional methods in this field.

### Embodiment 1

A preparation method of a samarium-cobalt permanent magnet with high mechanical properties in this embodiment comprises the following steps.

(1) Melting: Mix raw materials according to the molecular formula Sm(CO_{bal}Fe_{0.21}Cu_{0.062}Zr_{0.024})_{7.36}, with an additional 4% (mass fraction) compensation amount for samarium during the mixing process; place the raw materials in a vacuum melting furnace, evacuate the furnace to a vacuum degree of 3×10⁻² Pa, and then fill with high-purity argon; heat to 1450° C. for melting, hold for 5 min, and then pour a high-temperature alloy solution into a water-cooled copper mold to form an alloy ingot.

(2) Pulverizing: Perform coarse crushing and jet milling on the alloy ingot obtained in Step (1), where the alloy ingot is crushed to below 300 μm by coarse crushing, and the coarse magnetic powder obtained after coarse crushing is further ground to generate magnetic powder with a particle size of 4 μm.

(3) Orientation shaping and cold isostatic pressing: Place the magnetic powder obtained in Step (2) in a magnetic field press with a magnetic field intensity of 2 T under the protection of nitrogen for orientation shaping, vacuum-package a prepared green compact, and place it in isostatic pressing equipment, where it is compressed at 180 MPa for 30 s to produce a samarium-cobalt permanent magnet alloy blank.

(4) Pre-sinter the samarium-cobalt permanent magnet alloy blank obtained in Step (3) at 1180° C. for 1 h, and then sinter at 1200° C. for 2 h under the protection of argon.

(5) After sintering, perform solution heat treatment at 1190° C. for 4 h, followed by cooling to obtain a samarium-cobalt permanent magnet solid solution.

(6) Under the protection of argon, perform isothermal heat treatment on the samarium-cobalt permanent magnet solid solution obtained in Step (5) at 830° C. for 20 h, then slowly cool to 400° C. at 0.7° C./min, hold for 3 h, and finally cool naturally in the furnace to room temperature to obtain a samarium-cobalt sample.

(7) In a high-purity argon atmosphere, heat the samarium-cobalt sample obtained in Step (6) at 1° C./min to 810° C., perform isothermal heat treatment for 10 min, apply an external magnetic field of 10 kOe (the external magnetic field is located at both sides of the sample, with the sample placed at the center of the magnetic field, and the direction of the external magnetic field is parallel to the easy magnetization axis of the sample) and an external stress of 100 MPa (the direction of the external stress is parallel to the direction of the magnetic field) during the heating process, then cool the sample down to room temperature slowly in the furnace, and remove the magnetic field and stress to obtain the final samarium-cobalt product.

### Embodiment 2

Embodiment 2 is different from Embodiment 1 only in Step (7). The Step (7) of Embodiment 2 involves heating the samarium-cobalt sample at 1° C./min to 810° C. in a high-purity argon atmosphere, performing isothermal heat treatment for 30 min, applying an external magnetic field of 10 kOe and an external stress of 100 MPa during the heating process, then cooling the sample down to room temperature slowly in the furnace, and removing the magnetic field and stress to obtain the final samarium-cobalt product.

### Embodiment 3

Embodiment 3 is different from Embodiment 1 only in Step (7). The Step (7) of Embodiment 3 involves heating the samarium-cobalt sample at 1° C./min to 810° C. in a high-purity argon atmosphere, performing isothermal heat treatment for 60 min, applying an external magnetic field of 10 kOe and an external stress of 100 MPa during the heating process, then cooling the sample down to room temperature slowly in the furnace, and removing the magnetic field and stress to obtain the final samarium-cobalt product.

### Embodiment 4

Embodiment 4 is different from Embodiment 1 only in Step (7). The Step (7) of Embodiment 4 involves heating the samarium-cobalt sample at 1° C./min to 600° C. in a high-purity argon atmosphere, performing isothermal heat treatment for 10 min, applying an external magnetic field of 10 kOe and an external stress of 100 MPa during the heating process, then cooling the sample down to room temperature slowly in the furnace, and removing the magnetic field and stress to obtain the final samarium-cobalt product.

### Embodiment 5

Embodiment 5 is different from Embodiment 1 only in Step (7). The Step (7) of Embodiment 5 involves heating the samarium-cobalt sample at 1° C./min to 400° C. in a high-purity argon atmosphere, performing isothermal heat treatment for 10 min, applying an external magnetic field of 10 kOe and an external stress of 100 MPa during the heating process, then cooling the sample down to room temperature slowly in the furnace, and removing the magnetic field and stress to obtain the final samarium-cobalt product.

### Embodiment 6

Embodiment 6 is different from Embodiment 1 only in Step (7). The Step (7) of Embodiment 6 involves heating the samarium-cobalt sample at 1° C./min to 400° C. in a high-purity argon atmosphere, performing isothermal heat treatment for 30 min, applying an external magnetic field of 10 kOe and an external stress of 100 MPa during the heating process, then cooling the sample down to room temperature slowly in the furnace, and removing the magnetic field and stress to obtain the final samarium-cobalt product.

### Embodiment 7

Embodiment 7 is different from Embodiment 1 only in Step (7). The Step (7) of Embodiment 7 involves heating the samarium-cobalt sample at 1° C./min to 810° C. in a high-purity argon atmosphere, performing isothermal heat treatment for 30 min, applying an external magnetic field of 10 kOe and an external stress of 100 MPa during the heating process, slowly cooling to 400° C., performing isothermal heat treatment for 60 min, then cooling the sample down to room temperature slowly in the furnace, and removing the magnetic field and stress to obtain the final samarium-cobalt product.

### Embodiment 8

Embodiment 8 is different from Embodiment 1 only in Step (7). The Step (7) of Embodiment 8 involves heating the samarium-cobalt sample at 1° C./min to 810° C. in a high-purity argon atmosphere, performing isothermal heat treatment for 30 min, applying an external magnetic field of 10 kOe and an external stress of 100 MPa during the heating process, performing isothermal heat treatment for 30 min, then removing the magnetic field and stress, then slowly cooling to 400° C., performing isothermal heat treatment for 60 min, and finally cooling the sample down to room temperature slowly in the furnace to obtain the final samarium-cobalt product.

### Embodiment 9

Embodiment 9 is different from Embodiment 1 only in Step (7). The Step (7) of Embodiment 9 involves heating the samarium-cobalt sample at 1.2° C./min to 700° C. in a high-purity argon atmosphere, performing isothermal heat treatment for 20 min, applying an external magnetic field of 5 kOe and an external stress of 200 MPa during the heating process, performing isothermal heat treatment for 20 min, then removing the magnetic field and stress, and finally cooling the sample down to room temperature slowly in the furnace to obtain the final samarium-cobalt product.

### Embodiment 10

Embodiment 10 is different from Embodiment 1 only in Step (7). The Step (7) of Embodiment 10 involves heating the samarium-cobalt sample at 0.8° C./min to 810° C. in a high-purity argon atmosphere, performing isothermal heat treatment for 40 min, applying an external magnetic field of 15 kOe and an external stress of 150 MPa during the heating process, then cooling the sample down to room temperature slowly in the furnace, and removing the magnetic field and stress to obtain the final samarium-cobalt product.

### Comparative Example 1

Comparative example 1 differs from Embodiment 1 only in that there is no Step (7) in Comparative example 1.

### Comparative Example 2

Comparative example 2 differs from Embodiment 1 only in that the Step (7) of Comparative example 2 involves heating the samarium-cobalt sample at 1° C./min to 810° C. in a high-purity argon atmosphere, performing isothermal heat treatment for 10 min, applying no external magnetic field or external stress during the heating treatment process, and finally cooling the sample down to room temperature slowly in the furnace to obtain the final samarium-cobalt product.

### Comparative example 3

Comparative example 3 is different from Embodiment 1 only in that the Step (7) of Comparative example 3 involves heating the samarium-cobalt sample at 1° C./min to 810° C. in a high-purity argon atmosphere, performing isothermal heat treatment for 10 min, applying an external magnetic field of 10 kOe but no external stress during the heating process, then cooling the sample down to room temperature slowly in the furnace, and removing the magnetic field to obtain the final samarium-cobalt product.

### Comparative example 4

Comparative example 4 is different from Embodiment 1 only in that the Step (7) of Comparative example 4 involves heating the samarium-cobalt sample at 1° C./min to 810° C. in a high-purity argon atmosphere, performing isothermal heat treatment for 10 min, applying an external stress of 100 MPa but not external magnetic field during the heating process, then cooling the sample down to room temperature slowly in the furnace, and removing the external stress to obtain the final samarium-cobalt product.

The magnetic properties and mechanical properties of the samarium-cobalt permanent magnets obtained in the above embodiments and comparative examples were characterized at room temperature, and the samarium-cobalt permanent magnets were processed into φ10×10 mm for magnetic performance testing. A standard sample of h×b×1=5×6×20 mm was manufactured and used to test the bending strength of the samarium-cobalt permanent magnets, with the height direction parallel to the easy magnetization axis, that is, h//c. The results are shown in Table 1.

TABLE 1
Magnetic Properties and Bending Strength of
Samarium-Cobalt Permanent Magnets Obtained
in Embodiments and Comparative Examples

| | | | Magnetic | |
|---|---|---|---|---|
| | | Coer- | energy | Bending |
| | Remanence | civity | product | strength/ |
| | Br/kGs | Hcj/kOe | (BH)max/MGOe | MPa |
| Embodiment 1 | 10.59 | 34.28 | 29.33 | 260 |
| Embodiment 2 | 10.54 | 33.26 | 29.15 | 275 |
| Embodiment 3 | 10.52 | 30.71 | 28.71 | 230 |
| Embodiment 4 | 10.36 | 32.21 | 25.91 | 212 |
| Embodiment 5 | 10.31 | 36.8 | 25.54 | 157 |
| Embodiment 6 | 10.32 | 35.96 | 25.57 | 176 |
| Embodiment 7 | 10.62 | 36.65 | 27.46 | 292 |
| Embodiment 8 | 10.58 | 34.85 | 28.11 | 283 |
| Embodiment 9 | 10.42 | 33.35 | 25.82 | 226 |
| Embodiment 10 | 10.57 | 34.05 | 28.95 | 262 |
| Comparative | 10.41 | 31.73 | 25.43 | 126 |
| example 1 | | | | |
| Comparative | 10.45 | 32.05 | 25.89 | 140 |
| example 2 | | | | |
| Comparative | 10.51 | 32.93 | 26.85 | 200 |
| example 3 | | | | |
| Comparative | 10.46 | 32.52 | 26.11 | 185 |
| example 4 | | | | |

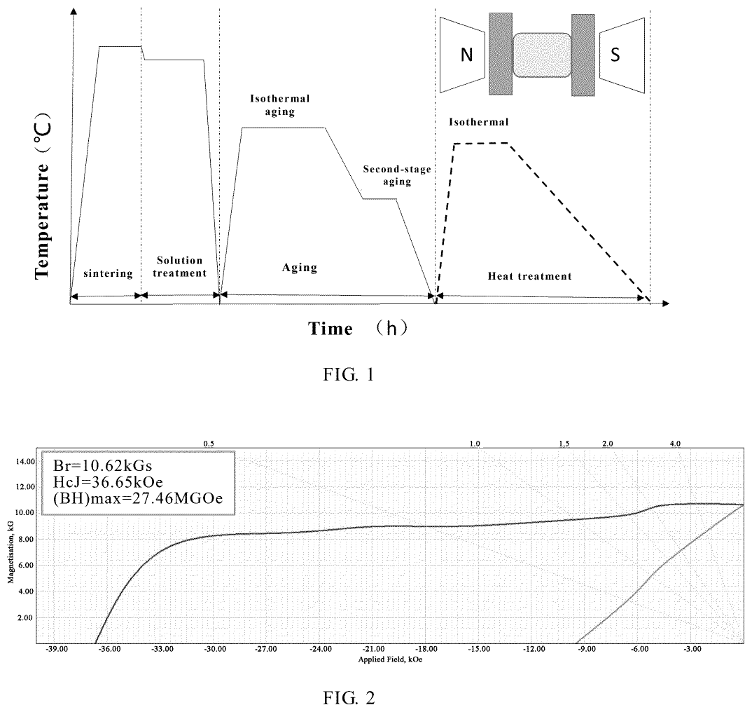

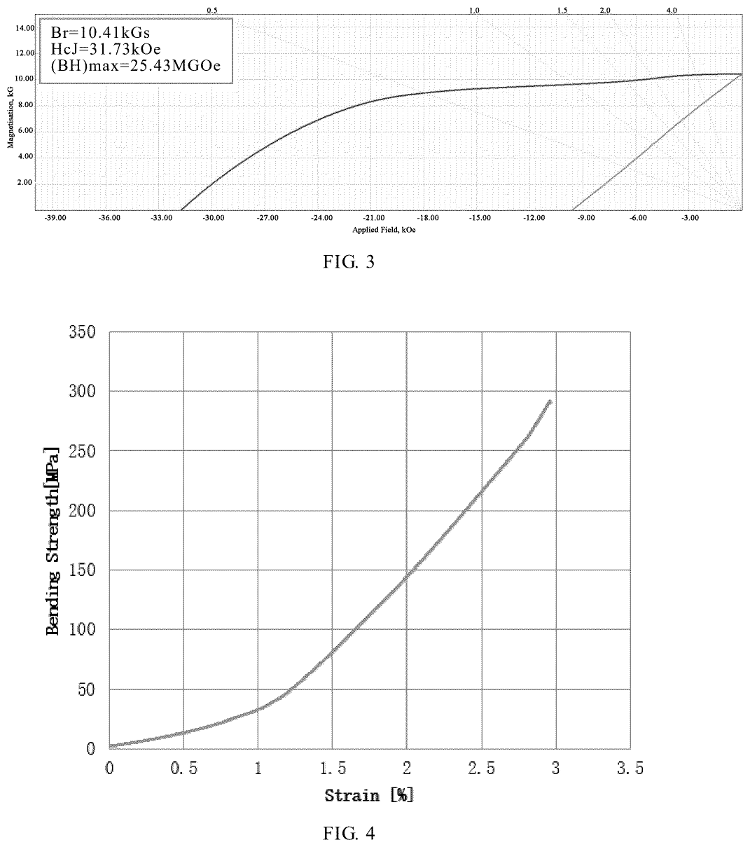

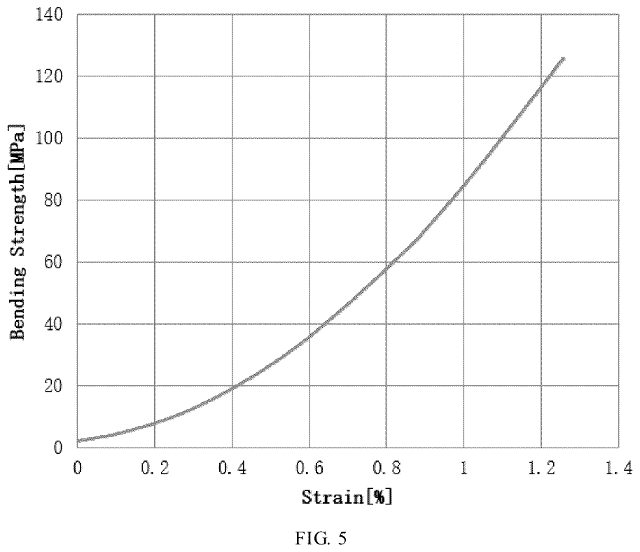

FIG. 3 is a graph showing the magnetic properties of a samarium-cobalt magnet according to Comparative example 1, and FIG. 5 is a bending stress-strain diagram of a samarium-cobalt magnet according to Comparative example 1. Compared with the performance of Comparative example 1 based on the traditional process scheme, the coercivity and magnetic energy product of the samarium-cobalt magnets in Embodiments 1-10 are improved, with maximum values achieved in Embodiment 1, where the magnetic energy product is 29.33 MGOe; the bending strength of the samarium-cobalt magnets is also greatly improved, by 24.6-131.7%, with maximum values achieved in Embodiment 7; in Embodiment 7, additional secondary isothermal heat treatment at 400° C. for 60 min is conducted, the coercivity and mechanical properties are improved, and as shown in FIGS. 2 and 4, the bending strength is as high as 292 Mpa. Embodiments 1-3 involve isothermal heat treatment at 810° C. for different durations. As the aging time increases, the mechanical properties first increase and then decrease, while the magnetic properties gradually decline. However, all the properties remain superior to the comparative examples. Embodiment 4 involves isothermal heat treatment at 600° C. for 10 min. Compared to isothermal heat treatment at 810° C. for 10 min, the mechanical properties show a significant decrease. Embodiments 5-6 involve isothermal heat treatment at 400° C. for different durations. As the aging time increases, the mechanical properties improve, but the magnetic properties do not change significantly. This is likely because the coercivity of the samarium-cobalt magnets remains high at 400° C., and the external magnetic field is relatively small, so the magnets cannot be fully saturated, resulting in a minor impact on the magnetic properties.

Comparative example 2 only involves heat treatment, without the application of an external magnetic field or stress. From the experimental results of

Comparative example 1 and Comparative example 2, it can be seen that heat treatment without external magnetic field and stress has no significant effect on the magnetic properties and bending strength of magnets. Comparative example 3 and Comparative example 4 involve the application of either external magnetic field or external stress, respectively. The experimental results of Comparative example 1, Comparative example 3, and Comparative example 4 show that when only a magnetic field or stress is applied during heat treatment, the increase in bending strength is very limited.

Based on the above analysis, it can be seen that the magnetic properties and mechanical properties of samarium-cobalt magnets can be improved through the application of magnetic field, stress, and isothermal heat treatment. This is likely because the external magnetic field and external stress provide external driving forces that promote lattice distortion within the magnets, accelerating the diffusion of elements between the unit cells and grain boundaries. Compared to the traditional preparation process, the addition of magnetic field, stress, and isothermal heat treatment leads to more thorough element diffusion within the magnets, resulting in an increased number of precipitates. The pinning effect of these precipitates on domain walls is enhanced. Additionally, the appropriate temperature, magnetic field intensity, aging time, and stress level can refine the grains, increase the number of grain boundaries, and hinder the crack propagation, thereby improving the mechanical properties of the magnets. As the heat treatment temperature increases within a certain range, the mechanical properties can be significantly improved.

The various aspects, embodiments and features of the invention should be regarded as illustrative in all aspects and not limiting the invention, and the scope of the invention is only defined by the Claims. Other embodiments, modifications and uses will be apparent to those skilled in the art without departing from the spirit and scope of the claimed invention.

In the preparation method of the invention, the order of the steps is not limited to the order listed, and it is also within the protection scope of the invention for those of ordinary skill in the art to change the order of the steps without creative labor. Furthermore, two or more steps or actions can be performed simultaneously.

Finally, it should be noted that the specific embodiments described herein are only illustrative of the invention, and do not serve to limit the implementation modes of this invention. Those skilled in the technical field to which the invention belongs can make various modifications or supplements to the described specific embodiments or adopt similar methods to replace them, and it is unnecessary and impossible to give a complete example of all the implementation modes here. However, these obvious changes or variations derived from the essential spirit of the invention still belong to the scope of protection of the invention, and it is against the spirit of the invention to interpret them as any additional restrictions.

What is claimed is:

1. A preparation method of a samarium-cobalt permanent magnet with high mechanical properties, comprising:
performing melting, pulverizing, orientation shaping, cold isostatic pressing, sintering, solution treatment, aging and heat treatment successively on raw materials to obtain the samarium-cobalt permanent magnet;
wherein the heat treatment is conducted in an inert atmosphere, the number of heat treatment cycles ranges from 1 to 10, and an external magnetic field and an external stress are applied during one or multiple heat treatment cycles.

2. The preparation method of a samarium-cobalt permanent magnet with high mechanical properties according to claim 1, wherein the number of heat treatment cycles ranges from 1 to 10, and when the number of heat treatment cycles is more than or equal to 2, the temperature is cooled down to 10-50° C. during each heat treatment cycle, and then heated up again for the next heat treatment cycle.

3. The preparation method of a samarium-cobalt permanent magnet with high mechanical properties according to claim 1, wherein the holding temperature for each heat treatment cycle is 350° C.≤T<Curie temperature, and the holding time for each heat treatment cycle is 3-90 min.

4. The preparation method of a samarium-cobalt permanent magnet with high mechanical properties according to claim 1, wherein each heat treatment cycle consists of one or two stages, and the external magnetic field and the external stress are applied during one of the stages or both stages;
when the heat treatment cycle consists of one stage, the holding temperature for the one-stage heat treatment is 350° C.≤T<Curie temperature, and the holding time for the one-stage heat treatment is 3-90 min;
when the heat treatment cycle consists of two stages, the holding temperature for the first-stage heat treatment is 350° C.≤T<Curie temperature, and the holding time is 3-90 min; and the holding temperature for the second-stage heat treatment is 350° C.≤T<Curie temperature, and the holding time is 3-90 min.

5. The preparation method of a samarium-cobalt permanent magnet with high mechanical properties according to claim 4, wherein when the heat treatment cycle consists of two stages, the holding temperature for the first-stage heat treatment is 700-850° C., and the holding time is 3-90 min; and the holding temperature for the second-stage heat treatment is 350-600° C., and the holding time is 3-90 min.

6. The preparation method of a samarium-cobalt permanent magnet with high mechanical properties according to claim 1, wherein a magnetic field intensity of the external magnetic field is 1-50 kOe.

7. The preparation method of a samarium-cobalt permanent magnet with high mechanical properties according to claim 1, wherein the magnitude of the external stress is 5-500 MPa.

8. The preparation method of a samarium-cobalt permanent magnet with high mechanical properties according to claim 1, wherein a magnetic field intensity of the external magnetic field is 5-10 kOe, and the magnitude of the external stress is 50-200 MPa.

9. The preparation method of a samarium-cobalt permanent magnet with high mechanical properties according to claim 1, wherein the external magnetic field is located at both sides of a sample, and the sample is placed at a center of the magnetic field; and
the external magnetic field is applied in one of the following directions: horizontal, vertical, or at any angle.

10. The preparation method of a samarium-cobalt permanent magnet with high mechanical properties according to claim 1, wherein a direction of the external magnetic field is parallel to an easy magnetization axis of a sample.

11. The preparation method of a samarium-cobalt permanent magnet with high mechanical properties according to claim 1, wherein a direction of the external stress is parallel to a direction of the external magnetic field.

12. A samarium-cobalt permanent magnet with high mechanical properties prepared by the preparation method according to claim 1.

13. The samarium-cobalt permanent magnet with high mechanical properties according to claim 12, wherein a maximum bending strength of the samarium-cobalt permanent magnet is more than or equal to 150 MPa.
